(19) United States
(12) Patent Application Publication
(10) Pub. No.: US 2026/0340440 A1
(43) Pub. Date: Oct. 29, 2026

(54) METHOD, DEVICE, AND COMPUTER PROGRAM PRODUCT FOR DATA ATTRIBUTION

(71) Applicant: Dell Products L.P., Round Rock, TX (US)

(72) Inventors: Sicong Yao, Shanghai (CN); Changsheng Ren, Shanghai (CN); Weihua Geng, Chengdu (CN)

(21) Appl. No.: 19/556,752

(22) Filed: Mar. 4, 2026

(30) Foreign Application Priority Data
Apr. 25, 2025 (CN) 202510530281.X

(51) Int. Cl. G06N 5/022; G06F 9/30

(52) U.S. Cl. CPC G06N 5/022; G06F 9/3009

(57) ABSTRACT

Techniques for data attribution involve acquiring a historical dataset and a plurality of thread calling functions corresponding to the historical dataset. Such techniques further involve constructing a knowledge graph based on the historical dataset and the plurality of thread calling functions. Such techniques further involve determining, based on a thread calling function of current data, historical data in the knowledge graph that is associated with the current data and is used to attribute the current data.

### CROSS-REFERENCE TO RELATED APPLICATION

This application claims priority to Chinese Patent Application No. CN202510530281.X, on file at the China National Intellectual Property Administration (CNIPA), having a filing date of Apr. 25, 2025, and having “METHOD, DEVICE, AND COMPUTER PROGRAM PRODUCT FOR DATA ATTRIBUTION” as a title, the contents and teachings of which are herein incorporated by reference in their entirety.

### TECHNICAL FIELD

The present invention relates to the field of computers, and more particularly, to a method, device, and computer program product for data attribution.

### BACKGROUND

Currently, during operation and maintenance of a storage server (such as a network-attached storage server), analysis of data unavailability issues usually relies on R&D personnel to manually parse core dump files and locate root causes of failures by checking thread calling stacks, context parameters, and the like. This process requires developers to rely on their personal experience to accumulate professional knowledge such as in-depth understanding of system architecture and file access protocols.

It is also possible to use a keyword search function of a defect tracking system to match historical issues, so as to determine whether a new issue is a repetition of a known defect. Such tools are based on text matching logic, and keywords entered by users are compared with historical issue descriptions or solutions to support issue classification.

### SUMMARY OF THE INVENTION

A method, device, and computer program product for data attribution are provided in embodiments of the present disclosure.

In a first aspect of the embodiments of the present disclosure, a method for data attribution is provided. The method includes acquiring a historical dataset and a plurality of thread calling functions corresponding to the historical dataset. The method further includes constructing a knowledge graph based on the historical dataset and the plurality of thread calling functions. The method further includes determining, based on a thread calling function of current data, historical data in the knowledge graph that is associated with the current data and is used to attribute the current data.

In a second aspect of the embodiments of the present disclosure, an electronic device is provided. The electronic device includes one or a plurality of processors; and a storage apparatus configured to store one or a plurality of programs, the one or a plurality of programs, when executed by the one or a plurality of processors, causing the one or a plurality of processors to implement a method for data attribution. The method includes acquiring a historical dataset and a plurality of thread calling functions corresponding to the historical dataset. The method further includes constructing a knowledge graph based on the historical dataset and the plurality of thread calling functions. The method further includes determining, based on a thread calling function of current data, historical data in the knowledge graph that is associated with the current data and is used to attribute the current data.

In a third aspect of the embodiments of the present disclosure, a computer-readable storage medium having a computer program stored thereon is provided, and the program, when executed by a processor, implements a method for data attribution. The method includes acquiring a historical dataset and a plurality of thread calling functions corresponding to the historical dataset. The method further includes constructing a knowledge graph based on the historical dataset and the plurality of thread calling functions. The method further includes determining, based on a thread calling function of current data, historical data in the knowledge graph that is associated with the current data and is used to attribute the current data.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 illustrates a schematic diagram of an example environment in which a plurality of embodiments of the present disclosure can be implemented;

FIG. 2 illustrates a flow chart of a method for data attribution according to some embodiments of the present disclosure;

FIG. 3 illustrates a schematic diagram of a knowledge graph including one piece of historical data according to some embodiments of the present disclosure;

FIG. 4 illustrates a flow chart of a method of adding new historical data into a knowledge graph according to some embodiments of the present disclosure;

FIG. 5 illustrates a schematic diagram of a knowledge graph including a plurality of pieces of historical data according to some embodiments of the present disclosure; and

FIG. 6 illustrates a block diagram of a device that can implement a plurality of embodiments of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

As mentioned above, although R&D personnel can manually locate the root causes of data unavailability issues, locating cross-field issues requires collaboration among a plurality of teams, resulting in high communication costs. The parsing process of core dump files is repetitive and time-consuming, making it difficult to improve the efficiency. In addition, the dispersion of personal experience causes that similar issues may result in repeated consumption of resources due to personnel changes or insufficient collaboration, and therefore, it is difficult to form systematic knowledge accumulation.

At the same time, the search method using keywords also has limitations in practical applications. General tools lack structured integration of storage server field knowledge, and it is difficult to accurately associate thread patterns with the root causes of issues. In addition, text matching is easily affected by differences in expression, resulting in frequent missed detection or false detection, and therefore, a reference value of the solution is limited and unable to meet requirements of rapid classification in complex scenarios.

To this end, the embodiments of the present disclosure provide a method, device, and computer program product for data attribution. The method is acquiring a historical dataset and a plurality of thread calling functions corresponding to the historical dataset, then constructing a knowledge graph based on the historical dataset and the plurality of thread calling functions, and finally determining, according to a thread calling function of current data, historical data in the knowledge graph that is associated with the current data and is used to attribute the current data. In this way, the knowledge graph is utilized to transform the historical data and its thread calling function into a structured relational network, and historical data associated with the current data can be quickly filtered out by matching of the thread calling function, thereby effectively overcoming the problem of mismatching, improving the efficiency and accuracy of attribution, and avoiding waste of resources.

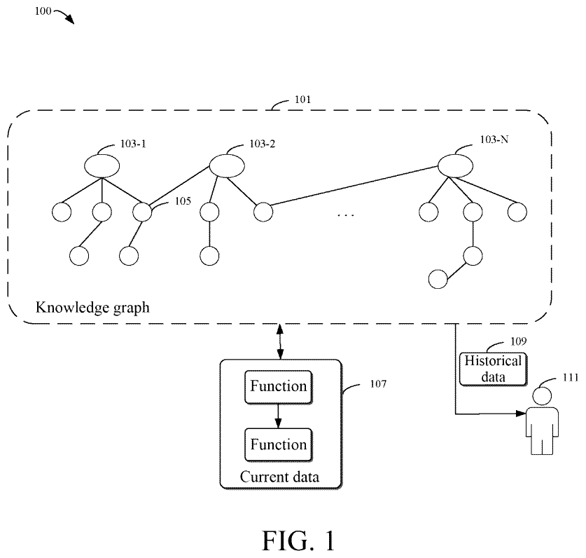

FIG. 1 illustrates a schematic diagram of an example environment 100 in which a plurality of embodiments of the present disclosure can be implemented. As shown in FIG. 1, the example environment 100 may include a knowledge graph 101. The knowledge graph 101 is a framework for expressing, storing, and associating knowledge in the form of a graph structure, and the essence thereof is constructing a semantic network through nodes and edges to describe concepts, entities, and associations. The knowledge graph 101 may be used to integrate heterogeneous data, and support knowledge reasoning, semantic search, and intelligent decision-making, such as helping search engines to directly present structured answers. The knowledge graph 101 usually includes a root node and child nodes. The root node usually refers to a starting node representing a core entity or ontology concept of a field, serves as a central hub for information aggregation, and defines a subject boundary of the graph. The child node is a specific instance or attribute directly associated with the root node, which is used to refine knowledge and expand details. The two are dynamically connected through relationship edges to form a hierarchical semantic network. The child node may further serve as a root node of other nodes, so that the knowledge graph 101 presents a non-linear complex association structure.

In an embodiment of the present disclosure, the knowledge graph may be constructed by acquiring a historical dataset and a plurality of thread calling functions corresponding to the historical dataset. The historical dataset may include a plurality of pieces of historical data, and the historical data may be various types of data unavailability issues, such as a storage volume being unable to mount, a file access timeout, or metadata corruption. Each piece of historical data usually corresponds to at least one thread calling function. A thread is the smallest execution unit scheduled by an operating system, and a calling function of the thread records the hierarchical calling relationship of functions during program execution. For example, a thread calling function of a certain piece of historical data may include a function calling frame NFSv4_Status Table: Close, and the function reflects an execution logic of a close operation of a protocol layer status table. The calling function is the specific step of the thread execution (such as resource locking, status update, or error handling), to which the historical data is directly associated. This association enables thread calling functions to be capable of representing the technical context of historical data and providing a basis for attribution analysis.

In some embodiments, after the historical dataset and the plurality of thread calling functions are acquired, the knowledge graph 101 can be constructed by mapping an identifier of the historical data to a root node and mapping the plurality of thread calling functions to child nodes. For example, as shown in FIG. 1, the knowledge graph 101 may include a root node 103-1, a root node 103-2, and a root node 103-N, the child nodes of each root node include the corresponding thread calling function, and one child node includes a frame of calling function. In some embodiments, different root nodes may also share the same child node. For example, the root node 103-1 and the root node 103-2 may share the child node 105. Of course, in addition to the above method, the thread calling function may also be used as the root node and the relevant historical dataset is used as the child node. A weight network may also be constructed based on function calling frequencies, and high-frequency calling functions may be used as core nodes to construct the knowledge graph 101. The present disclosure does not limit the method of constructing the knowledge graph 101. In this way, the historical dataset and the plurality of thread calling functions are structured, thereby providing efficient support for the rapid attribution of subsequent data unavailability issues.

In some embodiments, after the knowledge graph 101 is constructed, when a new data unavailability issue occurs, the knowledge graph 101 can be searched to determine historical data 109 associated with currently unavailable data, to serve as an attribution reference. For example, as shown in FIG. 1, by calculating a similarity between a thread calling function of current data 107 and the plurality of thread calling functions in the knowledge graph, the historical data 109 used to attribute the current data 107 can be determined and recommended to a technician 111. Alternatively, historical data 109 with a similar connection pattern may be matched according to a topological position of the calling function of the current issue 107 in the knowledge graph 101. Alternatively, abnormal features in the current thread calling function (such as an abnormal return value and a timeout mark) may be identified, and historical data 109 with similar abnormal features is searched for in the knowledge graph 101. The historical data 109 determined in the above manner can have a thread calling pattern and a function execution path similar to those of the current data 107, which indicates that the two may have the same root cause. For example, if both the historical data 109 and the current data 107 contain abnormal calls to the “NFSv4_Status Table: Close” function, it is likely that they both are caused by a status table management issue.

In this way, similar data can be quickly located through a structured knowledge graph, which greatly shortens the issue diagnosis time. Secondly, precise thread calling function matching can effectively avoid a semantic ambiguity issue of the conventional keyword search, thereby improving the attribution accuracy.

It should be understood that the architecture and functions in the example environment 100 are described only for illustrative purposes, without implying any limitation on the scope of the present disclosure. The embodiments of the present disclosure may also be applied to other environments having different structures and/or functions.

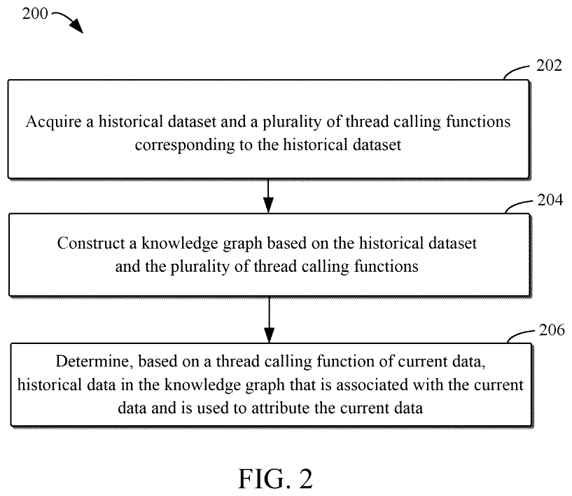

The processes according to the embodiments of the present disclosure will be described in detail below with reference to FIG. 2 to FIG. 6. For ease of understanding, the specific data referred to in the following description is all illustrative and is not intended to limit the scope of protection of the present disclosure. It should be understood that the embodiments described below may also include additional actions not shown and/or may omit actions shown, and the scope of the present disclosure is not limited in this regard.

FIG. 2 illustrates a flow chart of a method 200 for unloading a compressed load according to some embodiments of the present disclosure. The method 200 may be performed by a data attribution apparatus in an electronic device. The method 200 includes a block 202, a block 204, and a block 206. At the block 202, a historical dataset and a plurality of thread calling functions corresponding to the historical dataset are acquired. There are many ways to acquire the historical dataset and its corresponding thread calling functions. For example, relevant information about the historical data unavailability issue may be extracted from system logs, core dump files, or monitoring tools, and the corresponding thread calling functions may be parsed out by utilizing a debugging tool or performance analyzer. In some embodiments, in order to improve the search efficiency, the acquired thread calling functions may be filtered to retain only key function calls that have a great impact on the historical data. For example, by setting a threshold (also referred to as a first threshold) through statistical analysis or expert experience, function calls whose call frequency exceeds the threshold or whose appearance probability increases significantly when an anomaly occurs are filtered out. These functions often have a stronger causal relationship with the data unavailability issue, thereby providing a basis for subsequent rapid matching.

At the block 204, a knowledge graph is constructed based on the historical dataset and the plurality of thread calling functions. For example, as shown in FIG. 1, the knowledge graph 101 may be constructed by mapping an identifier of the historical data to a root node and mapping the plurality of thread calling functions to child nodes. The thread calling function may also be used as the root node and the relevant historical dataset is used as the child node. A weight network may also be constructed based on function calling frequencies, and high-frequency calling functions may be used as core nodes to construct the knowledge graph 101. The present disclosure does not limit the method of constructing the knowledge graph 101.

At the block 206, historical data in the knowledge graph that is associated with current data and is used to attribute the current data is determined based on a thread calling function of the current data. For example, as shown in FIG. 1, by calculating a similarity between a thread calling function of current data 107 and the plurality of thread calling functions in the knowledge graph, the historical data 109 used to attribute the current data 107 can be determined and recommended to a technician 111. Alternatively, historical data 109 with a similar connection pattern may be matched according to a topological position of the calling function of the current issue 107 in the knowledge graph 101. Alternatively, abnormal features in the current thread calling function (such as an abnormal return value and a timeout mark) may be identified, and historical data 109 with similar abnormal features is searched for in the knowledge graph 101. The historical data 109 determined in the above manner can have a thread calling pattern and a function execution path similar to those of the current data 107, which indicates that the two may have the same root cause. For example, if both the historical data 109 and the current data 107 contain abnormal calls to the “NFSv4_Status Table: Close” function, it is likely that they both are caused by a status table management issue.

In this way, the knowledge graph is utilized to transform the historical data and its thread calling function into a structured relational network, and historical data associated with the current data can be quickly filtered out by matching of the thread calling function, thereby effectively overcoming the problem of mismatching, improving the efficiency and accuracy of attribution, and avoiding waste of resources.

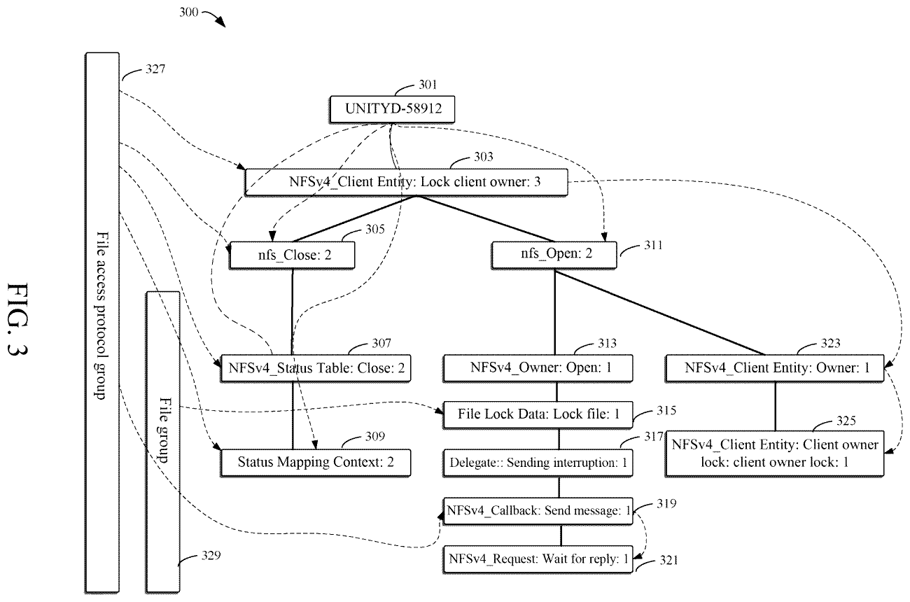

An example process for scheduling resources will be specifically described below with reference to FIG. 3 to FIG. 6. In the embodiments of the present disclosure, explanation is given in the order of constructing a knowledge graph including historical data, adding new historical data to the knowledge graph, and searching the knowledge graph. The specific data referred to in the following description is all illustrative and is not intended to limit the scope of protection of the present disclosure. It should be understood that the embodiments described below may also include additional actions not shown and/or may omit actions shown, and the scope of the present disclosure is not limited in this regard.

FIG. 3 illustrates a schematic diagram of a knowledge graph 300 including one piece of historical data according to some embodiments of the present disclosure. As mentioned above, there are many ways to construct the knowledge graph based on the historical dataset and the plurality of thread calling functions. The following description will take mapping an identifier of historical data to a root node and mapping a plurality of thread calling functions to child nodes to construct a knowledge graph as an example. As shown in FIG. 3, for historical data with a Jira identifier UNITYD-58912, a plurality of thread calling functions whose influence is greater than a threshold may be acquired first. The specific acquisition method is as described above and will not be repeated here. In the embodiments of the present disclosure, the historical data with a Jira identifier UNITYD-58912 involves 4 threads:

### Thread 1:

NFSV4_Client Entity: Lock client owner
Status Management Context: Status mapping context
NFSV4_Status Table: Close
NFSV4_Close

### Thread 2:

NFSV4_Client Entity: Lock client owner
Status Management Context: Status mapping context
NFSV4_Status Table: Close
NFSV4_Close

### Thread 3:

NFSV4_Request: Wait for reply
NFSV4_Callback: Send message
Delegate: Sending interruption
File_Lock Data: Lock file
NFSV4_Owner: Open
NFSV4_Open

### Thread 4:

NFSV4_Client Entity: Lock client owner
NFSV4_Client Entity: Client owner lock: client owner lock
NFSV4_Client Entity: Owner
NFSV4_Open

In some embodiments, UNITYD-58912 may be mapped to a root node 301, and the calling functions and context information of the four threads are mapped to the child nodes. At the same time, the child nodes may further include the number of function calls. As shown in FIG. 3, a child node 303 indicates that the NFSV4_Client Entity: Lock client owner function is called 3 times, and the function is used to lock an owner list of a client instance in an NFSv4 protocol to prevent concurrent access conflicts. A child node 305 indicates that the NFSV4_Close function is called 2 times, and the function is used to close an NFSv4 file handle and release related resources. A child node 307 indicates that the NFSV4 Status Table: Close function is called 2 times, and the function is used to clean up entries in an NFSv4 protocol status table. A node 309 indicates that the Status Management Context: Status mapping context function is called 2 times, and the function is used to manage context information of an NFSv4 protocol status machine. A child node 313 indicates that the NFSV4_Owner: Open function is called once, and the function is used to establish association between an NFSv4 file owner and a file. A child node 315 indicates that the NFSV4_Client Entity: Owner function is called once, and the function is used to obtain owner information of a client instance. A child node 325 indicates that the NFSV4_Client Entity: Client owner lock: client owner lock function is called once, and the function provides a lock mechanism for a client owner list. A child node 329 indicates that the NFSV4_Request: Wait for reply function is called once, and the function enables an NFSv4 client to wait for a response from a server. A child node 311 indicates that the NFSv4_Delegate: Sending interruption function is called once, and the function is used to interrupt an NFSv4 delegation operation. A child node 319 indicates that the NFSV4_Callback: Send message function is called once, and the function implements message sending of an NFSv4 callback mechanism. A child node 321 indicates that the File_Lock Data: Lock file function is called once, and the function provides a file lock management service. Therefore, it can be seen that in the embodiments of the present disclosure, the structural nodes of the knowledge graph sequentially include function name, count, child node, sibling node, and issue list.

In this way, each child node contains a complete record of the called function, the number of calls, and the context information. This structured storage method can accurately characterize a scenario where the issue occurs, provide a complete execution path tracing capability for subsequent issue analysis, and improve the accuracy of attribution positioning. For example, based on the record of the child node 303 that the “NFSV4_Client Entity: Lock client owner” function is called 3 times, the technician can quickly determine whether there is a lock contention issue.

As shown in FIG. 3, the child nodes may be arranged according to an actual execution order of the thread calling functions. This timing preservation property can completely reproduce a program execution flow when the issue occurs, helping technicians to intuitively understand the causal relationship between function calls. When an abnormal function is analyzed, it is possible to trace the preceding operations along the node sequence, so as to accurately locate a fault propagation path.

In some embodiments, an association relationship may further be established between a child node and a field group divided based on storage system architecture. The field group includes at least one of a file access protocol group, a file system group, a file group, and a volume group. For example, the node 303, the node 305, the node 307, the node 309, and the node 319 are associated with a file access protocol group 327, and the node 315 is associated with a file group 329. This hierarchical organization method can quickly focus on a module that may be involved in the issue through the field group, thereby narrowing the scope of analysis from the global system to a specific field. When a new issue is added, historical cases in the same field group can be matched first to improve the search efficiency. In addition, it can also facilitate collaboration among experts in different fields, with each being responsible for analysis in their respective fields of expertise. For example, experts in the file system group can focus on pattern analysis of related nodes without having to deal with technical details of the protocol layer, thereby achieving professional division of labor and knowledge reuse.

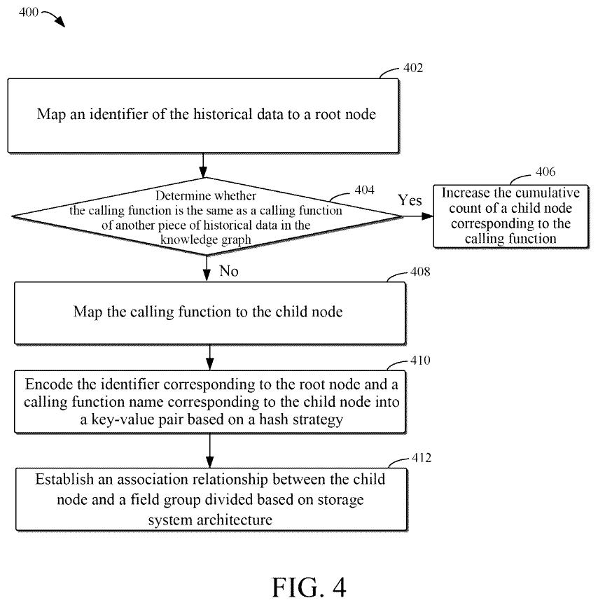

FIG. 4 illustrates a flow chart of a method 400 of adding new historical data into a knowledge graph according to some embodiments of the present disclosure. At a block 402, an identifier of the historical data is mapped to a root node. For example, as shown in FIG. 3, when there is a new data unavailability issue, an identifier corresponding to the new issue can be mapped to another root node. At a block 404, it is determined whether a calling function is the same as a calling function of another piece of historical data in the knowledge graph. For example, by comparing function names, calling hierarchies, and parameter features, it can be determined whether the calling function in the new issue already exists in the knowledge graph. In the same case, a block 406 is performed to increase the cumulative count of a child node corresponding to the calling function. For example, as shown in FIG. 3, if an original record of the child node 303 is that the function is called 3 times, and the newly added issue calls the function again, then the count is updated to 4 times. The present disclosure allows different root nodes to share the same child node, thereby reducing data redundancy, while revealing a high-frequency failure mode through frequency statistics to improve the subsequent search efficiency. In the case where the calling function is different from the calling function of another piece of historical data in the knowledge graph, a block 408 is performed to map the calling function to a child node. If the calling function does not exist in the knowledge graph, a new child node is created.

At a block 410, the identifier corresponding to the root node and a calling function name corresponding to the child node are encoded into a key-value pair based on a hash strategy. The identifier of the historical data may be converted into a unique hash value through a hash algorithm to serve as a key, and metadata of the child node, such as the number of calls and the associated field group, is used as a value. A hash mapping structure supports fast retrieval with O(1) time complexity. For example, child nodes can be directly located through hash keys, thereby avoiding traversing the entire graph and significantly improving the matching efficiency. At a block 412, association relationships are established between the child nodes and the field groups divided based on the storage system architecture. For example, as shown in FIG. 3, the node 303, the node 305, the node 307, the node 309, and the node 319 are associated with the file access protocol group 327, and the node 315 is associated with the file group 329. Association can be achieved through preset rules. For example, predefined field groups may be manually mapped to based on functional attributes of the calling functions. Function names may also be parsed through natural language processing. For example, functions containing “file lock” are automatically classified into the “file group.” Field group classification can quickly narrow the scope of issue analysis. When a new issue involves a file lock exception, the system preferentially matches historical nodes in the “file group” to avoid wasting resources for global searches.

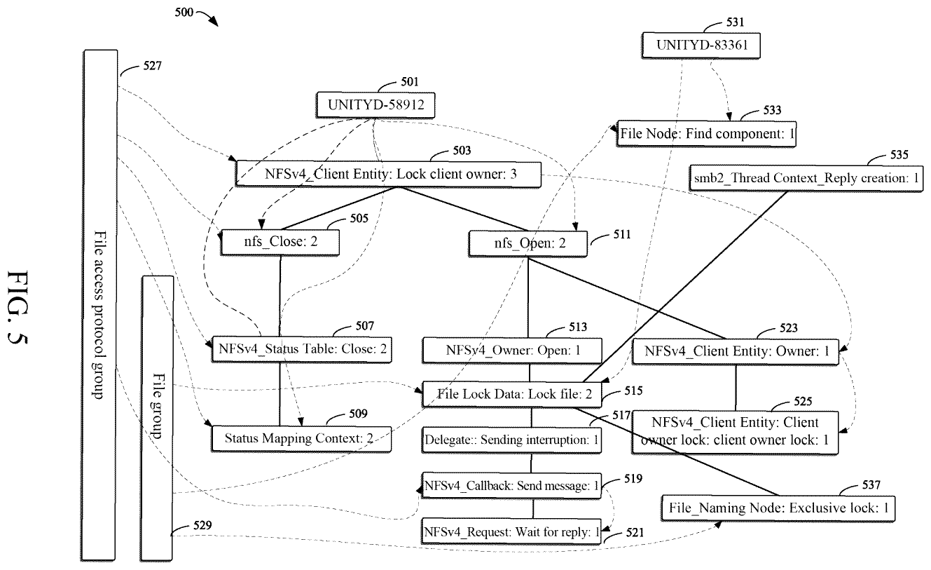

FIG. 5 illustrates a schematic diagram of a knowledge graph 500 including a plurality of pieces of historical data according to some embodiments of the present disclosure. As shown in FIG. 5, the knowledge graph 500 is a new knowledge graph constructed based on the knowledge graph 300 according to the steps shown in FIG. 4 when there is a new data unavailability issue. A root node 501 and a child node 503 to a child node 529 in FIG. 5 are consistent with the root node 301 and the child node 303 to the child node 329 in FIG. 3, which will not be repeated here. FIG. 3 is a knowledge graph constructed for the historical data having an identifier UNITYD-58912. The new historical data has an identifier UNITYD-83361, and UNITYD-83361 can be mapped to a root node 531.

As shown in FIG. 5, compared with the knowledge graph 300, the knowledge graph 500 creates new child nodes including a child node 533, a child node 535, and a child node 537. The child node 533 indicates that the NFSV4_Client Entity: Lock client owner function is called 3 times, and the function is mainly used to implement exclusive access control to the client instance owner list in the network file system protocol, and prevent, through a mutex lock mechanism, a plurality of threads from modifying the owner list at the same time to cause a data competition issue. The child node 535 indicates that the File Node: Find component function is called once, and the function is responsible for quickly locating a specific file component in the file system directory structure. The child node 537 indicates that the File Naming Node: Exclusive lock function is called once, and the function provides a fine-grained concurrency control mechanism for the file system. In addition, it can be seen that the root node 501 and the root node 531 share the child node 515. In FIG. 3, the number of calls of the child node 315 is 1, while in FIG. 5, the number of calls of the child node 515 is 2.

In some embodiments, after the knowledge graph is constructed, when a new data unavailability issue occurs, a similarity calculation method can be used to search the knowledge graph to find the corresponding historical data. The process may include calculating similarities (also referred to as a first similarity) of a plurality of thread calling functions in the knowledge graph with a thread calling function of current data one by one, and then calculating a similarity (also referred to as a second similarity) of each piece of historical data with the current data based on the similarities of the plurality of calling functions of each piece of historical data. Next, historical data in the historical dataset whose similarity is greater than a threshold (also referred to as a second threshold) may be determined as data used to attribute the current data. Finally, the historical data can be displayed from high to low according to the similarities of the historical data. When a technician selects one piece of the historical data, a field group divided based on the storage system architecture and a historical solution strategy corresponding to the thread calling function of the selected historical data are displayed. Taking a new issue SDNAS-20773 as an example, the system obtains a set of suspicious threads by filtering based on the longest hanging time, and the context is as follows:

### Thread 1:

NFSV4_Client Entity: Lock client owner
Status Management Context: Status mapping context
NFSV4_Status Table: Close
Network file system closed

### Thread 2:

NFSV4_Request: Wait for reply
NFSV4_Callback: Send message
Delegate: Sending interruption
File_Lock Data: Lock file
NFSV4_Owner: Open
Network file system open

### Thread 3:

NFSV4_Client Entity: Lock client owner
NFSV4_Client Entity: Client owner lock: client owner lock
NFSV4_Client Entity: Owner
Network file system open

### Thread 4:

File_Naming Node: Exclusive lock
File_Lock Data: Lock file
smb2_Thread Context: Reply creation

The knowledge graph is shown in FIG. 5, where knowledge of two root cause issues has been accumulated. These thread calling functions can be analyzed one by one. A function name in each frame can be indexed from a system hierarchy group, and therefore, the corresponding node in the knowledge graph can be quickly found. Final output results are shown in Table 1. Based on the output results, the system can provide technicians with suggestions on known issue similarities or matching possibilities. For example, a new issue may have a possibility of 83% of being associated with the known issue UNITYD-58912.

TABLE 1
Table of Issue Analysis Results

| Calling function name | Issue identifier | Similarity |
|---|---|---|
| NFSV4_Close | UNITYD-58912 | 83% |
| NFSV4_Status Table: Close | UNITYD-58912 | |
| Status Management Context: Status | UNITYD-58912 | |
| mapping context | | |
| NFSV4_Client Entity: Lock client owner | UNITYD-58912 | |
| NFSV4_Open | UNITYD-58912 | |
| File_Lock Data: Lock file | UNITYD-83361 | 17% |

In this way, by organizing the knowledge accumulated during historical issue processing, the knowledge can be more easily reused in future automatic classification. The knowledge is applied to the storage server as shared common knowledge, and the issue-solving experience and knowledge are particularly valuable to technical personnel. In the modern development process, converting personal knowledge into an intelligent knowledge database will greatly improve the efficiency of issue summarization, demonstration, and reference.

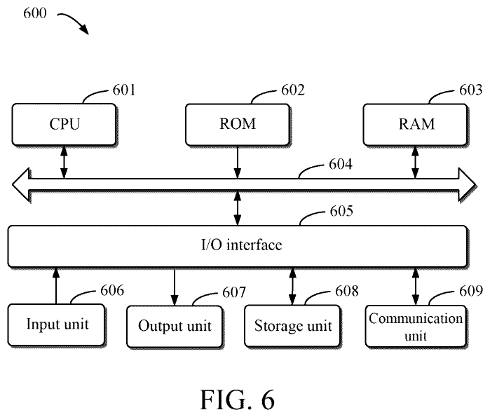

FIG. 6 illustrates a schematic block diagram of an example device 600 that can be used to implement an embodiment of the present disclosure. As shown in the figure, the device 600 includes a computing unit 601 that can perform various appropriate actions and processing according to computer program instructions stored in a read-only memory (ROM) 602 or computer program instructions loaded from a storage unit 608 to a random access memory (RAM) 603. Various programs and data required for the operation of the storage device 600 may also be stored in the RAM 603. The computing unit 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard or a mouse; an output unit 607, such as various types of displays or speakers; the storage unit 608, such as a magnetic disk or an optical disc; and a communication unit 609, such as a network card, a modem, or a wireless communication transceiver. The communication unit 609 allows the device 600 to exchange information/data with other devices via a computer network, such as the Internet, and/or various telecommunication networks.

The computing unit 601 may be various general-purpose and/or special-purpose processing components with processing and computing power. Some examples of the computing unit 601 include, but are not limited to, a central processing unit (CPU), a graphics processing unit (GPU), various specialized artificial intelligence (AI) computing chips, various computing units for running machine learning model algorithms, a digital signal processor (DSP), and any appropriate processor, controller, microcontroller, and the like. The computing unit 601 performs various methods and processing described above, such as the method 200. For example, in some embodiments, the method 200 may be implemented as a computer software program that is tangibly included in a machine-readable medium, such as the storage unit 608. In some embodiments, part of or all the computer program can be loaded and/or installed onto the device 600 via the ROM 602 and/or the communication unit 609. When the computer program is loaded to the RAM 603 and executed by the computing unit 601, one or more steps of the method 200 described above can be performed. Alternatively, in other embodiments, the computing unit 601 can be configured to perform the method 200 in any other suitable manners (e.g., by means of a firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOC), Load Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for data attribution, comprising:
acquiring a historical dataset and a plurality of thread calling functions corresponding to the historical dataset;
constructing a knowledge graph based on the historical dataset and the plurality of thread calling functions; and
determining, based on a thread calling function of current data, historical data in the knowledge graph that is associated with the current data and is used to attribute the current data.

2. The method according to claim 1, wherein the acquiring a historical dataset and a plurality of thread calling functions corresponding to the historical data comprises:
acquiring, for historical data in the historical dataset, at least one thread calling function whose influence on the historical data is greater than a first threshold.

3. The method according to claim 1, wherein the constructing a knowledge graph based on the historical dataset and the plurality of thread calling functions comprises:
mapping an identifier of the historical data to a root node; and
mapping the plurality of thread calling functions to child nodes to construct the knowledge graph, wherein an arrangement order of the child nodes corresponds to a calling order of the plurality of thread calling functions.

4. The method according to claim 3, wherein the constructing a knowledge graph based on the historical dataset and the plurality of thread calling functions further comprises:
encoding the identifier corresponding to the root node and a calling function name corresponding to the child node into a key-value pair based on a hash strategy; and
constructing the knowledge graph of a hash mapping structure based on the key-value pair.

5. The method according to claim 4, wherein the constructing a knowledge graph based on the historical dataset and the plurality of thread calling functions further comprises:
establishing an association relationship between the child node and a field group divided based on storage system architecture, wherein the field group comprises at least one of a file access protocol group, a file system group, a file group, and a volume group.

6. The method according to claim 5, wherein the historical dataset comprises first data and second data, and the constructing a knowledge graph based on the historical dataset and the plurality of thread calling functions further comprises:
determining whether a first calling function of the first data and a second calling function of the second data are the same calling function; and
in response to the first calling function of the first data and the second calling function of the second data being the same calling function, determining that the first data and the second data share the same child node, the child node comprising the calling function and the cumulative number of calls of the calling function.

7. The method according to claim 1, wherein the determining historical data in the knowledge graph that is associated with the current data and is used to attribute the current data comprises:
determining a plurality of first similarities between the plurality of thread calling functions in the knowledge graph and the thread calling function of the current data; and
determining the historical data based on the plurality of first similarities and a second threshold.

8. The method according to claim 7, wherein the determining the historical data comprises:
determining, based on the plurality of first similarities, a second similarity of each piece of historical data in the historical dataset; and
determining the historical data of which the second similarity is greater than the second threshold in the historical dataset as the data used to attribute the current data.

9. The method according to claim 8, further comprising:
displaying the historical data from high to low according to the second similarities of the historical data.

10. The method according to claim 9, further comprising:
in response to a user selecting one piece of the historical data, displaying a field group divided based on storage system architecture and a historical solution strategy corresponding to the thread calling function of the selected historical data.

11. An electronic device, comprising:
at least one processor; and
coupled to the at least one processor and having instructions stored therein, wherein the instructions, when executed by the at least one processor, cause the electronic device to perform the following:
acquiring a historical dataset and a plurality of thread calling functions corresponding to the historical dataset;
constructing a knowledge graph based on the historical dataset and the plurality of thread calling functions; and
determining, based on a thread calling function of current data, historical data in the knowledge graph that is associated with the current data and is used to attribute the current data.

12. The device according to claim 11, wherein the instruction for acquiring a historical dataset and a plurality of thread calling functions corresponding to the historical data comprises an instruction for:
acquiring, for historical data in the historical dataset, at least one thread calling function whose influence on the historical data is greater than a first threshold.

13. The device according to claim 11, wherein the instruction for constructing a knowledge graph based on the historical dataset and the plurality of thread calling functions comprises instructions for:
mapping an identifier of the historical data to a root node; and
mapping the plurality of thread calling functions to child nodes to construct the knowledge graph, wherein an arrangement order of the child nodes corresponds to a calling order of the plurality of thread calling functions.

14. The device according to claim 13, wherein the instruction for constructing a knowledge graph based on the historical dataset and the plurality of thread calling functions further comprises instructions for:
encoding the identifier corresponding to the root node and a calling function name corresponding to the child node into a key-value pair based on a hash strategy; and
constructing the knowledge graph of a hash mapping structure based on the key-value pair.

15. The device according to claim 14, wherein the instruction for constructing a knowledge graph based on the historical dataset and the plurality of thread calling functions further comprises an instruction for:
establishing an association relationship between the child node and a field group divided based on storage system architecture, wherein the field group comprises at least one of a file access protocol group, a file system group, a file group, and a volume group.

16. The device according to claim 15, wherein the historical dataset comprises first data and second data, and the instruction for constructing a knowledge graph based on the historical dataset and the plurality of thread calling functions further comprises instructions for:
determining whether a first calling function of the first data and a second calling function of the second data are the same calling function; and
in response to the first calling function of the first data and the second calling function of the second data being the same calling function, determining that the first data and the second data share the same child node, the child node comprising the calling function and the cumulative number of calls of the calling function.

17. The device according to claim 11, wherein the instruction for determining historical data in the knowledge graph that is associated with the current data and is used to attribute the current data comprises instructions for:
determining a plurality of first similarities between the plurality of thread calling functions in the knowledge graph and the thread calling function of the current data; and
determining the historical data based on the plurality of first similarities and a second threshold.

18. The device according to claim 17, wherein the instruction for determining the historical data further comprises instructions for:
determining, based on the plurality of first similarities, a second similarity of each piece of historical data in the historical dataset; and
determining the historical data of which the second similarity is greater than the second threshold in the historical dataset as the data used to attribute the current data.

19. The device according to claim 18, wherein the instructions, when executed by the at least one processor, further cause the electronic device to perform the following:
displaying the historical data from high to low according to the second similarities of the historical data.

20. A computer program product having a non-transitory computer readable medium which stores a set of instructions to perform data attribution; the set of instructions, when carried out by computerized circuitry, causing the computerized circuitry to perform a method of:
acquiring a historical dataset and a plurality of thread calling functions corresponding to the historical dataset;
constructing a knowledge graph based on the historical dataset and the plurality of thread calling functions; and
determining, based on a thread calling function of current data, historical data in the knowledge graph that is associated with the current data and is used to attribute the current data.
